(19) United States
(12) Patent Application Publication
(10) Pub. No.: US 2005/0266237 A1
(43) Pub. Date: Dec. 1, 2005

(54) Heat-activated sound and vibration damping sealant composition

(76) Inventors: Siddhartha Asthana, Ann Arbor, MI (US); Michael Speicher, Evansville, IN (US)

Correspondence Address: DINSMORE & SHOHL LLP;One Dayton Centre, Suite 1300, One South Main Street, Dayton, OH, 45402-2023, US

(21) Appl. No.: 10/857,121

(22) Filed: May 28, 2004

(51) Int. Cl. B32B 7/12

(52) U.S. Cl. 428/343; 428/346; 428/347; 428/349

(57) ABSTRACT

A heat-activated sound and vibration damping sealant composition is provided. The composition includes dried automotive paint powder and an unsaturated polymer, where the paint powder reacts with the unsaturated polymer when the composition is heated to greater than 200° F. (80° C.). Upon heating, composition expands and increases in tensile strength. The composition may be provided in the form of a tape which is adhered to a substrate such as an automotive or appliance part and then exposed to elevated temperatures such as those encountered in automotive, appliance, or other commercial paint bake processes. Thereafter, the composition provides sound and vibration damping properties.

### BACKGROUND OF THE INVENTION

The present invention is directed to a sound and vibration damping sealant composition for use in automotive or other applications, and more particularly, to a heat-activated sound and vibration damping sealant composition containing recycled automotive paint powder which may be used in automotive, appliance and other applications.

The paint and coatings industry is a major source of chemical wastes. Paint waste including paint sludge or paint powders is produced in the appliance industry, metal fabricating industry, and automotive industry. Such waste is generated when paint is sprayed onto a substrate such as an automobile part. The portion of the paint that does not affix to the part becomes waste paint. Current methods for disposing of waste paint include disposing the paint in landfills. However, the cost and the environmental impact of disposing of paint waste in this manner has become a concern in the industry.

In recent years, a number of processes have been developed for converting paint waste into useful products, thereby reducing the amount of waste which must be disposed of. For example, U.S. Pat. No. 5,954,970 teaches a method of treating paint sludge and processing it in the form of a dried powder which may be used as a component in asphalt, concrete, and sealants. U.S. Pat. No. 5,922,834 teaches a method for treating waste paint sludge which may be used in compositions such as pressure sensitive sealants automotive sealants, and asphalt cement coatings. Commonly assigned U.S. application Ser. No. 10/218,992, filed Aug. 14, 2002 (incorporated herein by reference) teaches a vibration damping composition which includes an amount of recycled automotive paint powder as a filler.

Accordingly, there is a need in the art for products which utilize large amounts of recycled paint powder in a variety of applications to further reduce or eliminate the amount of sludge which is disposed in landfills.

### SUMMARY OF THE INVENTION

The present invention meets that need by providing a heat-activated sound and vibration damping sealant composition which contains recycled automotive paint powder to enhance the sound and vibration damping properties of the sealant. The recycled automotive paint powder also functions to expand the sealant upon heating. The sound and vibration damping sealant composition may be provided in the form of a tape or a three-dimensional article which can be secured to a substrate such as an automotive part and then heated to expand the composition.

According to one aspect of the present invention, a heat-activated sound and vibration damping sealant composition is provided comprising recycled automotive paint powder, an unsaturated polymer, and a blowing agent, where the sealant composition expands upon being heated.

By “recycled automotive paint powder,” it is meant dried, cured polymer resin formed by treating paint waste generated in an automotive paint spray process such as those described in U.S. Pat. Nos. 5,573,587, 5,765,293 and 6,099,898, the disclosures of which are incorporated herein by reference.

By “unsaturated polymer,” it is meant a polymer which contains olefinic unsaturated points. The unsaturated polymer is preferably selected from the group consisting of rubbers, block copolymers, polyolefins, acrylic and methacrylic polymers and copolymers, polyamides, polyesters, styrene-buatdiene rubbers, styrene-butadiene block copolymers, ethylene-propylene copolymers, ethylene-vinyl acetate copolymers, ionomers, and blends thereof.

The composition contains one or more heat activated blowing agents. We have found that, due to the presence of the recycled paint powder, the sealant composition expands upon heating, which can reduce the amount of blowing agent(s) needed in the composition to achieve proper expansion.

To achieve expansion, the sealant composition is preferably heated to a temperature of greater than about 200° F. (80° C.), and more preferably, between about 250° F. and 400° F. (120° C. and 205° C.).

In a preferred embodiment of the invention, the sealant composition comprises approximately equal amounts of the recycled automotive paint powder and the unsaturated polymer. The composition may further include additives such as fillers, antioxidants and UV light stabilizers. The composition may also includes desiccants such as calcium oxide (lime) or molecular sieves. The composition also preferably includes a plasticizer and a tackifier. The composition also preferably includes a curing agent.

In one embodiment of the invention, the heat-activated sound and vibration damping sealant composition is in the form of a tape having first and second major surfaces. The tape preferably has a thickness of about 0.5 to 2.0 mm. In an alternative embodiment of the invention, the composition is provided in the form of a three-dimensional article.

In another embodiment of the invention, a sound and vibration damping structure is provided comprising, in combination, a substrate having first and second surfaces; and a heat-activated sound and vibration damping sealant composition adhered to at least one surface of the substrate which comprises recycled automotive paint powder, an unsaturated polymer, and a blowing agent. The substrate preferably comprises a material selected from the group consisting of metal, wood, glass, plastic and fabric. Preferably, the substrate comprises an automotive or appliance part.

The vibration damping structure may be formed by applying the sound and vibration damping sealant composition to at least one area of the substrate and then heating the substrate with the composition thereon to a temperature of at least 200° F. (80° C.), which causes the composition to expand. The sealant composition may be provided in the form of a tape or three-dimensional article as described above.

The method may further include painting the substrate with the sealant composition thereon. For example, the method may include passing the substrate through a paint bake cycle. By “paint bake cycle”, it is meant a process in which the composition is secured to a substrate such as an automotive, appliance, or other commercial part; primed, painted, and then passed through a paint bake oven which is used to cure painted parts. The oven temperatures in a paint bake cycle typically range from about 200° F. to 300° F. (80° C. to 150° C.), which causes the sealant composition to expand.

Accordingly, it is a feature of the present invention to provide a heat-activated sound and vibration damping sealant composition which may be adhered to a substrate such as an automotive or appliance part and heated such that it expands. Other features and advantages of the invention will be apparent from the following description, the accompanying drawings, and the appended claims.

### BRIEF DESCRIPTION OF THE DRAWINGS

FIG. 1 is a perspective view of a tape formed from the heat-activated sound and vibration damping sealant composition of the present invention;

FIG. 2 is a perspective view of a three-dimensional article formed from the sealant composition of the present invention; and

FIG. 3 is a perspective view of the sound and vibration damping tape adhered to a substrate.

### DETAILED DESCRIPTION OF THE PREFERRED EMBODIMENTS

The heat-activated sound and vibration damping sealant composition of the present invention provides a number of advantages over prior vibration damping materials used in automotive or appliance applications. We have found that the use of recycled automotive paint powder unexpectedly contributes to the vibration damping properties of the composition. While not wishing to be bound to a particular theory, it is believed that the high organic content (about 70 to 80% by weight) of the paint powder is effective in absorbing sound and vibration energy, particularly in the glass transition region of the polymeric materials contained in the powder. We have found that acrylic and methacrylic polymers and copolymers are prevalent in the powder and have a glass transition (Tg) of about 120° C., while various other polymers in the powder have lower glass transition temperatures. The effective Tg is further reduced due to the presence of low molecular weight species in the sealant composition which may have a plasticizer effect on the polymers contained in the powder. Thus, sound and vibrational energy created by automobiles or appliances is converted into internal vibrational, rotational, and/or translational motions by the polymers in the powder.

The improvement in the sound and vibration damping properties resulting from the inclusion of the paint powder typically occurs at higher temperature ranges, i.e., at about 40° C. and above. This is an improvement over prior art vibration damping compositions which typically do not exhibit good damping properties at higher temperatures. However, it should be appreciated that the sound and vibration damping sealant composition may also be formulated to exhibit good sound and damping properties at lower temperatures by selecting polymers which provide better damping performance at low temperatures such as styrene-butadiene rubber, chlorobutyl rubbers, and bromobutyl rubbers.

The recycled automotive paint powder used in the sealant of the present invention is comprised of cured, mixed polymeric species. While not wishing to be bound to a particular theory, we believe that these polymers decompose upon heating and thereby create polymer species with free radicals and also release molecules with reactive functionalities. The free radicals created are capable of adding onto any unsaturations in polymers and monomeric species contained in the unsaturated polymer component(s) in the composition. The free radicals can also transfer the reactive sites onto another molecule; therefore, other mechanisms which could take place upon heating including radical combination, disproportionation, and inter- and intra-molecular cyclizations.

The preferred paint powder for use in the present invention is Dry Pure II (trademark), commercially available from Haden, Inc. The recycled paint powder is preferably included in the composition in amounts which are equivalent to the amount of unsaturated polymer.

If desired, the recycled automotive paint powder may be pretreated prior to use as described in commonly-assigned U.S. application Ser. No. 10/401,828, incorporated herein by reference. By “pretreated”, it is meant that the paint powder is heated to a temperature sufficient to reduce the volatile compounds in the paint powder. However, it should be appreciated that if pretreated paint powder is used, the amount of blowing agents included in the sealant composition may need to be adjusted.

The sound and vibration damping sealant composition comprises, as the unsaturated polymer component, rubbers, block copolymers, polyolefins, acrylic and methacrylic polymers and copolymers, polyamides, polyesters, styrene-butadiene rubbers, styrene-butadiene block copolymers, ethylene-propylene copolymers, ethylene-vinyl acetate copolymers, ionomers, and blends thereof.

Preferred rubbers for use in the invention include butyl rubber, EPDM, Ethylene-propylene rubber, halogenated butyl rubber, nitrile rubbers, polybutadiene, polyisoprenes, polisobutylenes, chlorinated polybutadienes, styrene-butadiene and block copolymers of styrene-butadiene, and natural rubber. Suitable butyl rubbers include Butyl 065, 077, 165, 268 or 365, Exxpro 96-1, commercially available from ExxonMobil Chemical. The butyl rubber may also comprise PB-100, PB-101, PB-301, or PB-402, all commercially available from Bayer. Suitable halogenated butyl rubbers include Bromobutyl 2030 or X-2, or Chlorobutyl 1240 or 1255, commercially available from Bayer; or Bromobutyl 2222, 2244, or 2255, or Chlorobutyl HT-1065, HT-1066, or HT-1068, commercially available from ExxonMobil Chemical.

Suitable ethylene-propylene-diene terpolymers (EPDM) include Vistalon 2200, 2504, 5600 or 6505, commercially available from ExxonMobil Chemical; Royalene 501, 502, and 521; commercially available from Uniroyal Chemica; Keltan 21, 2340A, 2506, 40A or 4506, all commercially available from DSM copolymer; Nordel 4520, commercially available from DuPont Dow Elastomers; or Trilenle 65, 66 and 67, all commercially available from Uniroyal Chemical.

A suitable polyisobutylene for use in the invention includes a high molecular weight polyisobutylenes suchas Vistanex L-80, L-100, L-120, or L-140, commercially available from ExxonMobil Chemical, or Oppanol B-50, B-80 or B-100, commercially available from BASF Corporation. The polyisobutylene may also comprise low molecular weight polyisobutylene such as Oppanol B-10, B-12, B-15 or B-30, commercially available from BASF Corporation, or P-10, P-12, or P-15, commercially available from Alcan Rubber and Chemical, or 4.0H, 4.5H, 5.0H, 5.5H, or 6HT, all commercially available from Rit-Chem.

Preferred block copolymers include block copolymers of styrene and butadiene or styrene and isoprene. Suitable commercially available styrene-based rubber polymers include Kraton® grades D1101, D1102, D1107, D111, D1112P, D1113P, D1116, D1117P, D1118X,1 D1119P, D1122X, D1124P, D1125P, D1184, D1193X, D1302X, D4141, D4158, D4433P, and Kraton® trades G1650, G1651, G1652, G1654, G1657, G1701, and G1726, all commercially available from Kraton Polymers, Inc.

Other suitable styrene-based rubber polymers include Septon™ grades 8007, 2007, 4004, 8076, 1020, 2063, 2006, 4055, 8006, 4033, and 8004, and Hybrar™ grades H5127, H5125, H7125, and H7311, all commercially available from Septon Company of America; and Vector™ grades 4111, 4113, 4114, 4211, 4213, 4215, 4230, 4411, 2411, 2518, 4461, 6241, and 8508, commercially available from ExxonMobil Chemical Company.

Preferred polyolefins for use are based on alpha-monoolefin monomers having 2-7 carbons and include ethylene, propylene, isobutylene, and mixtures of these monomers and their copolymers with acrylates and vinyl acetates.

One or more blowing agents are included in the composition to facilitate expansion of the sealant upon heating. Because the paint powder also functions as an auxiliary blowing agent upon heating, only small amounts of blowing agent(s) are needed. The blowing agent(s) may be included in amounts of from about 0.01 to 5% by weight. Suitable blowing agents include Unicell OH, commercially available from Tramaco. Other suitable blowing agents include dinitroso pentamethylene tetraamine (DNPT), p-toluene, sulfonylhydrazide (TSH), O-nitro (benzene sulfonyl hydrazide) (OBSH), azodicarbonamide (AZO). These, and other blowing agents may be used either alone or in combination with conventional blowing agent activators such as urea.

The sound and vibration damping sealant composition also preferably includes a compatible plasticizer. The plasticizer imparts softness and high initial adhesivity to the sealant composition, and also contributes to the sound damping properties of the composition. Suitable plasticizers include polybutene, such as Indopol H-100, H-300, H-1500 or H-1900, all commercially available from Amoco Chemical; and Parapol 700, 950, 1300, 2200 or 2500, all commercially available from ExxonMobil Chemical. Other suitable plasticizers include phthalate-type plasticizers including dibutyl, dicyclohexyl, diethyl, diisodecyl, dimethyl, dioctyl, diphenyl, diundecyl, butyl benzyl, available from Monsanto. Phosphate-type plasticizers can also be used which are commercially available from Monsanto. Mixtures of these plasticizers may also be used. The plasticizer is preferably included in the composition in amounts of from about 0.1 to 10% by weight of the composition.

The vibration damping sealant composition may also contain conventional inorganic fillers including, but not limited to, barium sulfate, calcium carbonate, diatomaceous earth, magnesium silicate, mica, hydrous aluminum silicate, and mixtures thereof. The inorganic filler(s) may comprise from about 1 to 40% by weight of the composition.

The composition may also include a tackifying resin, such as terpenes, hydrogenated polycyclic resins, rosin esters, or alilphatic and/or aromatic hydrocarbon resins. The tackifying resin is preferably present in an amount of from about 1 to 10% by weight to provide softness and high initial adhesivity to the composition.

Suitable hydrogenated polylicyclic resins include P-95, P-115, P-125 or P-140, commercially available from Arakawa Chemical; Escorez 5380, 5300, 5320 or 5340, commercially available from ExxonMobil Chemical; Regalite R91, R101, R125 or S260 and Regalrez 1018, 1085, 1094, 1126, 1128, 1139, 3102, 5095 or 6108, commercially available from Hercules; Eastotac H-100W, H-115W or H-130W, commercially available from Eastman Chemical; Sukorez SU-100, SU-110, SU-120 or SU-130, commercially available from Kolon Chemical.

Suitable aliphatic hydrocarbon resins include Escorez 1102, 1304, 1310LC, 1315 or 1504, commercially available from ExxonMobil Chemical; Nevtac 10, 80, 100 or 115, commercially available from Neville Chemical; Wingtack 10, 95 or Plus, commercially available from Goodyear Tire & Rubber; Eastotac H-100E, H-100R, H-100L, H-115E, H-115R, H-115L, H-130E, H-130R or H-130L, commercially available from Eastman Chemical; Adtac LV, Piccopale 100, Piccotac B, Piccotac 95 or Piccotac 115, commercially available from Hercules; Hikorez A-1100, A-1100S, C-1100, R-1100, R-1100S or T1080, commercially available from Kolon Chemical; ADHM-100, commercially available from Polysat. Suitable aromatic hydrocarbon resins include Nevchem 70, 100, 110, 120, 130, 140 or 150, commercially available from Neville Chemical; Escorez 7105 or 7312, commercially available from ExxonMobil Chemical; Hikotack P-90, P-90S, P-110S, P-120, P-120S, P-120HS, P-140, P-140M, P-150 or P-160, commercially available from Kolon Chemical; Picco 1104, 2100, 5120, 5130, 5140, 6085, 6100, 6115 or 9140, Piccodiene 2215 or Piccovar AP10, AP25 or L60, commercially available from Hercules.

Other suitable tackifying resins include coumarone indene resins, for example, Cumar P-10, P-25, R-1, R-3, R-5, R-6, R-7, R-9, R-10, R-11, R-12, R-13, R-14, R-15, R-16, R-17, R-19, R-21, R-27, R-28, R-29 or LX-509, commercially available from Neville Chemical; or Natrorez 10 or 25, commercially available from Natrochem. Another suitable tackifying resin is an ester of hydrogenated rosin, for example, Foral 85 or 105 or Pentalyn A or H or Hercolyn D or Stabelite Ester 10 or Albalyn, commercially available from Hercules; or Komotac KF-462S, commercially available from Komo Chemical. Mixtures of the above resins may also be used.

The vibration damping composition also preferably contains a dispersing agent comprising a fatty acid such as lauric acid, palmitic acid, stearic acid, oleic acid, linoleic acid, linolenic acid, elaeostearic acid, ricinoleic acid, and mixtures thereof. The dispersing agent may be included in an amount of from about 0.1 to 1% by weight of the composition.

The vibration damping composition also preferably includes a coloring agent. Suitable coloring agents include titanium dioxide, carbon black, and coal filler. The coloring agent is preferably included in an amount of from about 1 to 10% by weight.

The composition may also include a reinforcing agent such as silica. The reinforcing agent may be included in an amount of about 1 to 3% by weight of the composition. Preferred reinforcing agents include hydrophilic fumed silicas such as Aerosil 90, 130, 150, 200, 300 or 380, commercially available from Degussa; Cab-O-Sil H-5, HS-5, L-90, LM-130, LM-150, M-5, PTG, MS-55, or EH-5, commercially available from Cabot; hydrophobic fumed silicas, such as Aerosil R202, R805, R812, R812S, R972, R974 or US202, commercially available from Degussa; Cab-O-Sil TS-530, TS-610 or TS-720, commercially available from Cabot; hydrated amorphous precipitated silica, for example, Hi-Sil 132, 135, 210, 233, 243LD, 255, 532EP, 752, 900, 915 or 2000, commercially available from PPG Industries; Hubersil 162, 162LR, 1613, 1633, 1714, 1743, or 4151H, commercially available from J. M. Huber; or Garamite 1958, commercially available from Southern Clay Products. Mixtures of the above products may also be used.

Desiccants such as calcium oxide (lime), or molecular sieves may also be included in the composition in an amount of about 1 to 10% by weight of the composition, and more preferably, about 0.5 to 1.0% by weight.

The composition also preferably includes an adhesion promoter. A preferred adhesion promoter is an organosilane such as Silane A-174, A-187, A-189, or A-1100, commercially available from Osi Specialties; Sartomer 9050 or Sartomer 350, commercially available from Sartomer; Z-6040 or Z-6011, commercially available from Dow Corning; or AMEO-P, GLYMO, MEMO or MTMO, commercially available from Sivento. The adhesion promoter may be included in the composition in an amount of between about 0.1 to 1% by weight.

The composition also preferably includes an antioxidant in an amount comprising about 0.1 to 1% by weight of the composition. Suitable antioxidants include, but are not limited to Wingstay C, K, L S or T, commercially available from Goodyear, and Irganox 245, 259, 565, 1010, 1035, 1076, 1098, 1330, 1425, 1520 or 3144, commercially available from Ciba Specialty Chemicals.

The composition also preferably includes a curing agent in an amount comprising from about 0.01 to 5% by weight of the composition. A suitable cure package for use in the present invention includes DiCup 40C from Harwick.

The heat activated sound and vibration damping sealant composition is preferably formed by combining the recycled paint powder and unsaturated polymer(s) components in a sigma blade mixer or extruder. The blowing agent(s) are mixed separately in a sigma blade mixer or extruder. The components are mixed thoroughly in a conventional double-arm sigma blade mixer for about one to three hours to obtain good dispersion of all the components. Mixing times and temperatures may vary depending on the dispersion and the quality of mixing achieved in a particular mixer. Temperature must be monitored carefully when mixing the blowing agent(s) so that the mix temperature does not exceed the blowing temperature of the particular blowing agent(s) being used.

In situations where the addition of certain resins or other components may adversely affect the mix temperatures of the blowing agent or base compositions, such components are preferably included in a separately prepared modifier composition. Such a composition typically includes a mixture of resins such as a polyamide resin having a high softening point, a rosin-based resin, and ethylene vinyl acetate.

The separate base, blowing agent, and optional modifier mixtures are then pelletized into granules or pellets. The resulting pellets are then mixed together thoroughly along with a cure package in a feed hopper in the desired ratios.

Where the desired end product is a tape or sheet, the composition is extruded. Where the desired end product is in the form of a three-dimensional object, the composition is injection molded into the desired shape.

When the end product is a sheet or tape, the sheet or tape may be die cut into pieces or wound into coils. The tape may range in thickness from about 0.5 mm to 2.0 mm and may be provided in widths ranging from about 5 mm to 500 mm.

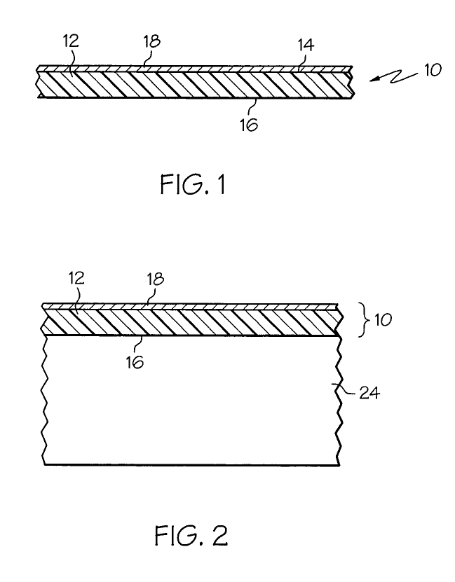

Referring now to FIG. 1, the heat-activated sound and vibration damping sealant composition 12 of the present invention is illustrated in the form of a tape 10. The tape is formed by extruding the sealant composition such that it has first and second surfaces 14 and 16.

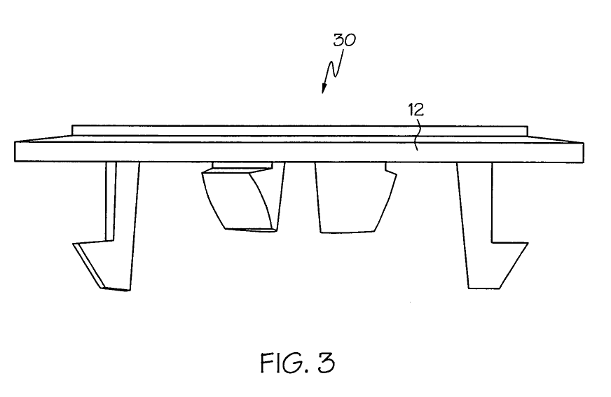

As shown in FIG. 2, the heat-activated vibration damping sealant tape 10 may be adhered to a substrate 24 such as an automotive or appliance part. The tape is adhered to the substrate on either side to the substrate 24. The tape is preferably adhered by heat staking or with the use of a pressure sensitive adhesive strip. While the tape is illustrated on only one area of the substrate, it should be appreciated that multiple pieces of tape may be applied to different areas of the substrate. The tapes may also be die cut in different sizes or shapes as needed, for example, in use with die-cut parts and extruded profiles.

FIG. 3 illustrates an alternative embodiment of the invention in which the sealant composition 12 is provided in the form of a three-dimensional article 30 which represents an automotive plug. The sealant composition may be formed into a three-dimensional article by injection molding the composition. The composition may be molded into automotive parts such as plugs or baffles. The three-dimensional article may be secured to a substrate such as an automotive part by the use of mechanical fasteners such as pins, or they can be heat staked or held in place with a pressure sensitive adhesive.

The tape or three-dimensional article may be adhered to a wide variety of substrates including, but not limited to, wood, glass, metal, painted or primed metals, and fabric. In automotive applications, the substrates may be in the form of galvanized metal, such as galvanized steel, galvanneal (a carbon steel panel which has been coated with an iron-zinc alloy which renders the panel corrosion resistant and paint ready), and painted or electrocoated metal. The composition may be used for example, to adhere to valve covers, baffles, oil pans, wheel wells, engine covers, pillars, firewalls, baffles, antiflutter devices on hoods, deck lids, side walls, underneath roof bows, weld-thru/non-weld thru seam sealers, and any other areas where sound and/or vibration damping is desired.

In appliance applications, the substrates may be in the form of metals such as aluminum and steel. The composition (in the form of a tape) may be adhered, for example, on unexposed perimeters of appliances.

The composition may also be applied to the interiors of office equipment utilizing steel and stainless steel substrates such as photocopiers, printers, and office furniture such as steel desks, chairs, etc.

Where the tape is used in automotive applications, the composition may be provided in the form of a tape or molded article which is secured to a substrate such as a molded automotive part and then processed through a paint bake cycle. After application of the tape or article to the substrate, the substrate with the tape on its surface is then processed through a paint bake cycle as shown. The paint bake cycle typically lasts for about 30 minutes at a temperature of about 250° F. to about 400° F. (120° C. to about 205° C.). The substrate may optionally be coated with a primer prior to painting. During the painting process, the composition is heated such that it expands. After the substrate and sealant composition have been passed through the paint bake cycle, the composition exhibits good sound and vibration damping properties.

In order that the invention may be more readily understood, reference is made to the following examples which are intended to illustrate the invention, but not limit the scope thereof.

### EXAMPLE 1

The following sound and vibration damping sealant compositions were formulated in accordance with the present invention and tested for composite loss factor using an Oberst test method based on ASTM E 756-93. Composite loss factor is a quantitative measure of the sound and vibration damping characteristics of a material. Simply, the higher the measured composite loss factor, the greater the material's ability to damp vibration.

The compositions are essentially identical except that the final formulation for composition 1 included paint powder while the final formulation for composition 2 contained no paint powder.

| | Composition 1 | Composition 2 |
|---|---|---|
| Base Pellets | (grams) | (grams) |
| modified ethylene-vinyl acetate | 698 | 698 |
| copolymer¹ | | |
| ethylene-methacrylic acid | 558 | 558 |
| ionomer² | | |
| styrene-butadiene rubber³ | 279 | 279 |
| rosin-based resin⁴ | 279 | 279 |
| zinc stearate | 1.37 | 1.37 |
| carbon black | 4.3 | 4.3 |
| Blowing Pellets | | |
| Blowing agent⁵ | 180 | 180 |
| ethylene-vinyl acetate⁶ | 500 | 500 |
| Modifier | | |
| rosin-based resin⁴ | 110 | 110 |
| ethylene-vinyl acetate | 1096 | 1096 |
| copolymer⁶ | | |
| polyamide resin⁷ | 395 | 395 |

| Final Formulation - | |
|---|---|
| Composition 1 | (grams) |
| Final formulation of Sample 2 | 1363 |
| Recycled Paint Powder⁸ | 69 |
| resin-based rosin⁴ | 68 |

| Final Formulation - | |
|---|---|
| Composition 2 | (grams) |
| Base Pellets | 468 |
| Blowing Pellets | 26 |
| Modifier | 19 |
| Curing Agent | 0.65 |

| 200 Hz Interpolated | | |
|---|---|---|
| Constrained Specimen Loss | | |
| Factor | Composition 1 | Composition 2 |
| −5° C. | 0.03 | 0.03 |
| 10° C. | 0.06 | 0.07 |
| 25° C. | 0.18 | 0.22 |
| 40° C. | 0.33 | 0.21 |
| 55° C. | 0.14 | 0.12 |

¹Bynell 2022 from Dupont
²Surlyn 9970 from Dupont
⁵Ameripol 1009 from Ameripol-Synpol
⁴Polypale resin from Eastman
⁵Unicell OH from Tramaco
⁶Elvax 410 from Dupont
⁷Versamid 125 from Henkel
⁸Dry Pure II from Haden Environmental

It can be sen from the data that composition 1 which includes the use of recycled paint powder has significantly improved sound and vibration properties at temperatures of 40° C. and 55° C. in comparison with composition 2 which contains no paint powder.

### EXAMPLE 2

The following sound and vibration damping sealant compositions were formulated in accordance with embodiments of the present invention and tested for composite loss factor as in Example 1. All compositions include the use of recycled paint powder and are essentially identical with the exception that different polymers were included in each of the formulations.

| | Composition 1 | Composition 2 | Composition 3 |
|---|---|---|---|
| Base Pellets | (grams) | (grams) | (grams) |
| styrene-butadiene | 120 | 120 | 120 |
| styrene¹ | | | |
| calcium carbonate | 99.4 | 99.4 | 99.4 |
| hydrocarbon resin² | 60 | 60 | 60 |
| plasticizer³ | 24 | 24 | 24 |
| carbon black | 24 | 24 | 24 |
| recycled paint | | | |
| powder⁴ | 150 | 150 | 150 |
| styrene butadiene | | | |
| rubber⁵ | 0 | 120 | 0 |
| ethylene-propylene- | | | |
| diene copolymer⁶ | 0 | 0 | 120 |
| ethylene-propylene- | | | |
| diene copolymer⁷ | 120 | 0 | 0 |
| | Composition 1 | Composition 2 | Composition 3 |
| Final Formulation | (grams) | (grams) | (grams) |
| Base | 600 | 600 | 600 |
| Curing Agent⁸ | 6 | 6 | 6 |
| Blowing agent⁹ | 12 | 12 | 12 |
| 200 Hz Interpolated | | | |
| Constrained Speci- | | | |
| men Loss Factor | Composition 1 | Composition 2 | Composition 3 |
| −5° C. | 0.03 | 0.07 | 0.04 |
| 10° C. | 0.13 | 0.2 | 0.13 |
| 25° C. | 0.68 | 0.43 | 0.55 |
| 40° C. | 0.24 | 0.11 | 0.3 |
| 55° C. | 0.08 | 0.05 | 0.11 |

¹H5127 from Septon Polymers
²Nevtac 100 from Neville Chemical
³Shellflex 3 from Shell Chemical
⁴Dry Pure II from Haden Environmental
⁵SR 1009 from Ameripol-Synpol
⁶Keltan 2506 from DSM Elastomer
⁷Nordel 1320 from Dupont-Dow
⁸DiCup 40C from Harwick
⁹Unicell OH from Tramaco

As can be seen, Composition 1 exhibits the best damping properties at a temperature of 25° C., Composition 2 exhibits the best damping properties at lower temperatures (−5° C., 10° C.), and Composition 3 exhibits the best damping properties at higher temperatures (40° C., 55° C.). The results demonstrate that the sound and vibration damping compositions may be designed to exhibit different loss factors at different temperatures, depending on the desired environments and end uses for the compositions.

### EXAMPLE 3

The following sound and vibration damping sealant compositions were formulated in accordance with embodiments of the present invention and tested for composite loss factor as in Example 1. Composition 1 included the use of recycled paint powder (untreated), and Composition 2 included the use of pretreated paint powder prepared in accordance with commonly-assigned application Serial No. Ser. No. 10/401,828. Composition 3 contained no paint powder.

| | Composition 1 | Composition 2 | Composition 3 |
|---|---|---|---|
| Base Pellets | (grams) | (grams) | (grams) |
| styrene-butadiene | 416.6 | 416.6 | 416.6 |
| styrene¹ | | | |
| calcium carbonate | 433.3 | 433.3 | 544.1 |
| plasticizer² | 41.6 | 41.6 | 41.6 |
| carbon black | 4.1 | 4.1 | 4.1 |
| recycled paint | | | |
| powder³ (pretreated) | 0 | 111.1 | 0 |
| recycled paint | | | |
| powder³ | 111.1 | 0 | 0 |
| resin⁴ | 104.1 | 104.1 | 104.1 |
| Blowing Pellets | | | |
| Blowing agent⁵ | 180 | 180 | 180 |
| Ethylene vinyl | 500 | 500 | 500 |
| acetate⁶ | | | |
| Final Formulation | | | |
| Base Pellets | 600 | 600 | 600 |
| Blowing Pellets | 24 | 24 | 24 |
| Curing agent⁷ | 12 | 12 | 12 |
| 200 Hz Interpolated | | | |
| Constrained Specimen | | | |
| Loss Factor | Composition 1 | Composition 2 | Composition 3 |
| −5° C. | 0.01 | 0.01 | 0.03 |
| 10° C. | 0.02 | 0.02 | 0.22 |
| 25° C. | 0.08 | 0.07 | 0.88 |
| 40° C. | 0.72 | 0.78 | 0.19 |
| 55° C. | 0.47 | 0.36 | 0.07 |

¹H5127 from Septon Polymers
²DIDP from ExxonMobil
³Dry Pure II from Haden Environmental
⁴Wingtac 95 from GoodYear
⁵Unicell OH from Tramaco
⁶Elvax 410 from Dupont
⁷DiCup 40C from Harwick

It can be seen from the data that compositions 1 and 2 which included the use of treated or untreated paint powder showed significantly better damping properties at temperatures of 40° C. and 55° C. in comparison with composition 3 which contained no paint powder.

It will be apparent to those skilled in the art that various changes may be made without departing from the scope of the invention which is not considered limited to those specific embodiments described in the specification.

1. A heat-activated sound and vibration damping sealant composition comprising:
recycled automotive paint powder;
an unsaturated polymer; and
a blowing agent; wherein said sealant composition expands upon being heated.

2. The sealant composition of claim 1 wherein said unsaturated polymer is selected from the group consisting of rubbers, block copolymers, polyolefins, acrylic and methacrylic polymers and copolymers, polyamides, polyesters, styrene-butadiene rubbers, styrene-butadiene block copolymers, ethylene-propylene copolymers, ethylene-vinyl acetate copolymers, ionomers, and blends thereof.

3. The sealant composition of claim 1 further including a plasticizer.

4. The sealant composition of claim 1 further including a tackifier.

5. The sealant composition of claim 1 wherein said sealant composition is heated to a temperature of greater than 200° F. (80° C.).

6. The sealant composition of claim 1 wherein said composition is heated to a temperature between about 200 and 400° F. (80° C. and 205° C.).

7. The sealant composition of claim 1 provided in the form of a tape having first and second major surfaces.

8. The sealant composition of claim 7 wherein said tape has a thickness of about 0.5 to 2.0 mm.

9. The sealant composition of claim 1 provided in the form of a three-dimensional article.

10. The sealant composition of claim 1 comprising approximately equal amounts of said recycled automotive paint powder and unsaturated polymer.

11. A sound and vibration damping structure comprising, in combination,
a substrate having first and second surfaces; and
a heat-activated vibration damping sealant composition adhered to at least one surface of said substrate, said sealant composition comprising recycled automotive paint powder, an unsaturated polymer, and a blowing agent; wherein said composition expands upon being heated to a temperature greater than about 200° F. (80° C.).

12. The structure of claim 11 wherein said substrate is comprised of a material selected from the group consisting of metal, wood, glass, plastic and fabric.

13. The structure of claim 11 wherein said composition is in the form of a tape.

14. The structure of claim 11 wherein said composition is in the form of a three-dimensional article.

15. A method of applying a heat-activated sound and vibration damping sealant composition to a substrate comprising:
a) providing a substrate;
b) providing a heat-activated vibration damping sealant composition comprising recycled automotive paint powder, an unsaturated polymer, and a blowing agent;
c) applying said sealant composition at least one area of said substrate; and
d) heating said substrate with said composition thereon to a temperature of at least 200° F. (80° C.).

16. The method of claim 15 wherein said sealant composition is in the form of a tape.

17. The method of claim 15 wherein said sealant composition is in the form of a three-dimensional article.

18. The method of claim 15 wherein said substrate is an automotive or appliance part.

19. The method of claim 15 wherein heating said substrate and composition to a temperature of at least 200° F. (80° C.) includes passing said substrate through a paint bake cycle.

20. The method of claim 15 wherein said heat-activated vibration damping sealant composition expands upon heating.
